(19) United States
(12) Patent Application Publication
(10) Pub. No.: US 2016/0283148 A1
(43) Pub. Date: Sep. 29, 2016

(54) BACKUP CONTROL DEVICE, BACKUP CONTROL METHOD, AND RECORDING MEDIUM

(71) Applicant: NEC Corporation, Tokyo (JP)

(72) Inventor: Shinta NAKAGAWA, Tokyo (JP)

(73) Assignee: NEC Corporation

(21) Appl. No.: 15/063,736

(22) Filed: Mar. 8, 2016

(30) Foreign Application Priority Data
Mar. 24, 2015 (JP) 2015-061198

(51) Int. Cl. G06F 3/06

(52) U.S. Cl. CPC G06F 3/0619; G06F 3/065; G06F 3/0683

(57) ABSTRACT

A backup control device includes a master storage unit, a snapshot storage unit, and a control unit. The master storage unit stores master data. The clone storage unit stores latest differential data of the master data. The snapshot storage unit stores snapshot data which is data at time of acquisition of backup of the clone storage unit. The control unit saves differential data into the snapshot storage unit when the differential data is present in the clone storage unit, and does not perform acquisition of the snapshot data when differential data is absent in the clone storage unit.

This application is based upon and claims the benefit of priority from Japanese Patent Application No. 2015-061198, filed on Mar. 24, 2015, the disclosure of which is incorporated herein in its entirety by reference.

### TECHNICAL FIELD

The present disclosure relates to a backup control device, a backup control method, and a recording medium.

### BACKGROUND ART

As an approach to realize multiple versions of backup with respect to an operation volume, there exists a snapshot acquisition technique with a copy-on-write method (Japanese Patent Application Laid-open No. 2004-192133). In a system using this technique, copying of data is not implemented at the point when backup has been acquired, but a part to be written is backed up as differential data at the point when there has been writing into an operation volume. That is, data to be backed up is acquired into a snapshot file at the point when a difference from an operation volume has occurred.

When reading an older version that has been backed up, this system references an operation volume or backup data corresponding to a version in which there has been writing most recently with respect to a part to be read.

Accordingly, this technique can reduce the storage area for backup. A system using this technique generally includes a difference management table for determining the presence or absence of a difference among respective versions.

There also exists a system in which data common among multiple volumes is included in a master volume and in which only differential data corresponding to each volume with respect to the master volume is associated and included in each volume (Japanese Unexamined Patent Application Publication (Translation of PCT Application) No. 2014-517363). A volume storing differential data is called a clone volume. This system determines the presence or absence of a difference of a master volume and a clone volume, using a difference management table. In order to maintain an image of a master volume, this system does not perform writing into the master volume, but holds write data in a clone volume.

### SUMMARY

For backup to the clone volume described above, there is a demand to acquire a snapshot. In order to meet this demand, there needs to be a combination of the technique of Japanese Patent Application Laid-open No. 2004-192133 and the technique of Japanese Unexamined Patent Application Publication (Translation of PCT Application) No. 2014-517363. Note that, in a system with a mere combination of these techniques, data needs to be read from a master volume and saved as a snapshot, in order to hold data corresponding to an earlier version of a differential clone volume, in the case where differential data does not exist in a clone volume. Considering a case where data corresponding to a master volume does not change, this processing is pointless.

One of exemplary objects of the present disclosure is to provide a backup control device, a backup control method, and a program recording medium for eliminating the pointlessness described above.

A backup control device according to an exemplary aspect of the disclosure includes a master storage unit that stores master data, a clone storage unit that stores latest differential data of the master data, a snapshot storage unit that stores snapshot data, the snapshot data being data at time of acquisition of backup of the clone storage unit, and a control unit that saves differential data into the snapshot storage unit when the differential data is present in the clone storage unit, and does not perform acquisition of the snapshot data when differential data is absent in the clone storage unit.

A backup control method according to an exemplary aspect of the disclosure includes storing master data, and upon receiving an update request of a clone storage unit that stores latest differential data of the master data after acquisition of backup of the clone storage unit, saving, when the differential data is present in the clone storage unit, the differential data into a snapshot storage unit, and not performing acquisition of the snapshot data when differential data is absent in the clone storage unit.

### BRIEF DESCRIPTION OF THE DRAWINGS

Exemplary features and advantages of the present disclosure will become apparent from the following detailed description when taken with the accompanying drawings in which:

FIG. 1 is a block diagram showing an example of the configuration of a backup control device;

FIG. 2 is a diagram showing a configuration example of a clone difference table;

FIG. 3 is a diagram showing a configuration example of a snapshot acquisition destination table;

FIG. 4 is a diagram showing a configuration example of a snapshot difference table;

FIG. 5 is a flowchart showing one example of clone acquisition command processing;

FIG. 6 is a flowchart showing an example of write command processing;

FIG. 7 is a flowchart showing an example of read command processing;

FIG. 8 is a flowchart showing an example of clone delete command processing;

FIG. 9 is a flowchart showing an example of snapshot acquisition command processing;

FIG. 10 is a flowchart showing an example of snapshot read command processing;

FIG. 11A is a flowchart showing a part of an example of snapshot restoration command processing;

FIG. 11B is a flowchart showing another part of the snapshot restoration command processing;

FIG. 12 is a flowchart showing an example of snapshot delete command processing;

FIG. 13 is a flowchart showing an example of snapshot delete command processing;

FIG. 14 is a block diagram showing another example of the configuration of a backup control device;

FIG. 15 is a block diagram showing yet another example of the configuration of a backup control device; and

FIG. 16 is a block diagram showing an example of the configuration of a computer device.

### EXEMPLARY EMBODIMENT

### First Exemplary Embodiment

### Configuration

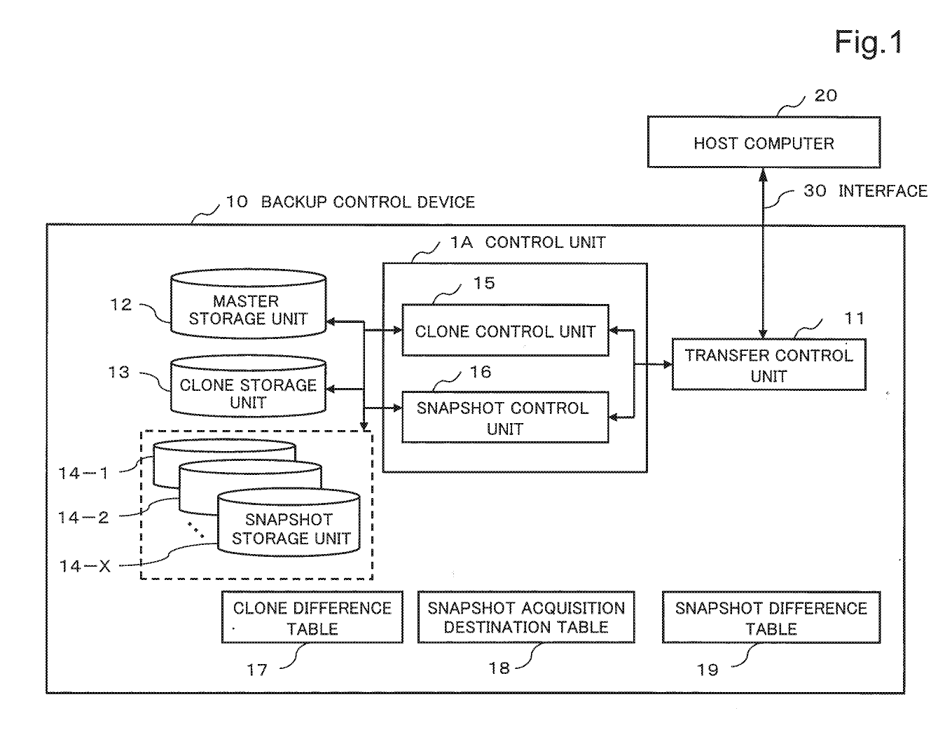

FIG. 1 is a diagram showing the configuration of a backup control device 10 according to a first exemplary embodiment of the present disclosure. The backup control device 10 is connected with a host computer 20 via an interface 30. The backup control device 10 is recognized as, for example, a disk array device from the host computer 20. Arrows drawn in the block diagrams in FIG. 1 and thereafter are drawn in order to show one example of the flow of data and are not intended to limit the flow of data.

The backup control device 10 includes a transfer control unit 11, a master storage unit 12, a clone storage unit 13, snapshot storage units 14, a clone control unit 15, and a snapshot control unit 16. The clone control unit 15 and the snapshot control unit 16 may be not separate, but implemented collectively as a control unit 1A.

Further, the backup control device 10 stores a clone difference table 17, a snapshot acquisition destination table 18, and a snapshot difference table 19 in a memory.

The interface 30 is connected to the transfer control unit 11. The transfer control unit 11, the clone control unit 15, and the snapshot control unit 16 are connected to each other. Further, the clone control unit 15, the snapshot control unit 16, the master storage unit 12, the clone storage unit 13, and the snapshot storage units 14 are connected to each other.

The master storage unit 12, the clone storage unit 13, and the snapshot storage unit 14 are storage devices recording byte data sequences in units of sectors of fixed length. These storage devices are, for example, a disk device or a semiconductor storage device. In this description and the drawings, the master storage unit 12, the clone storage unit 13, and the snapshot storage unit 14 are in some cases respectively described simply as “master”, “clone”, and “snapshot”.

Writing to the master storage unit 12 is prohibited while the backup control device 10 is running. When there is a change request for data (hereinafter referred to as “master data”) stored in the master storage unit 12, the clone control unit 15 writes changed content into the clone storage unit 13. The written data is called differential data. When a read request for latest data has been received, the clone control unit 15 reads the data if the differential data exists in a read target sector, or reads master data if the differential data does not exist.

The snapshot control unit 16 acquires backup of differential data stored in the clone storage unit 13 repetitively (for example, at certain intervals). The snapshot control unit 16 acquires backup through a copy-on-write method. That is, the snapshot control unit 16 does not implement copying of data at the point when backup has been acquired, but saves, into the snapshot storage unit 14, pre-update data (hereinafter referred to as “snapshot data”) of a part to be written, at the point when there has been writing into the clone storage unit 13. When data recovery of the backed-up clone storage unit 13 has been requested, the snapshot control unit 16 performs recovery using snapshot data. The backup control device 10 of the exemplary embodiment may use master data for this recovery.

The snapshot storage unit 14 exists for every version of backup of the clone storage unit 13. In FIG. 1, X (where X is any natural number) snapshot storage units 14 exist. That is, FIG. 1 shows an example in which X versions of backup of the clone storage unit 13 exist.

The transfer control unit 11 receives a group of commands (requests) from the host computer 20, transmits the commands to the clone control unit 15, and waits for completion. This command group includes, for example, a clone acquisition command, a write command, a read command, and a clone delete command. With the transfer control unit 11, after completion of the transmitted commands, an execution result of the command and a byte data sequence are received from the clone control unit 15 and transferred to the host computer 20.

The transfer control unit 11 receives a different group of commands from the host computer 20, transmits the commands to the snapshot control unit 16, and waits for completion. This command group includes, for example, a snapshot acquisition command, a snapshot read command, a snapshot restoration command, and a snapshot delete command. With the transfer control unit 11, after completion of the transmitted commands, an execution result of the command and a byte data sequence are received from the snapshot control unit 16 and transferred to the host computer 20.

A write command includes a sector number and a byte data sequence. A read command includes a sector number. A snapshot read command includes a version number and a sector number. A snapshot restoration command and a snapshot delete command both include a version number. Herein, a version number is a number that is 1 for the first version and incremented by 1 along with the succession of versions.

Upon receiving a write command, the clone storage unit 13 stores a byte data sequence designated with respect to a sector of a designated sector number and transmits an execution result to a transmission source of the command. When a read command has been received, the clone storage unit 13 transmits a byte data sequence stored in a sector of a designated sector number to a transmission source of the command.

Herein, the transfer control unit 11, the clone control unit 15, and the snapshot control unit 16 are configured of logic circuitry. The transfer control unit 11, the clone control unit 15, and the snapshot control unit 16 may be realized by a program executed by a processor of the backup control device 10 that is a computer.

When the clone control unit 15 and the snapshot control unit 16 are implemented collectively as the control unit 1A, the control unit 1A may be configured of logic circuitry. Alternatively, the control unit 1A may be realized by a program executed by a processor, not shown, of the backup control device 10.

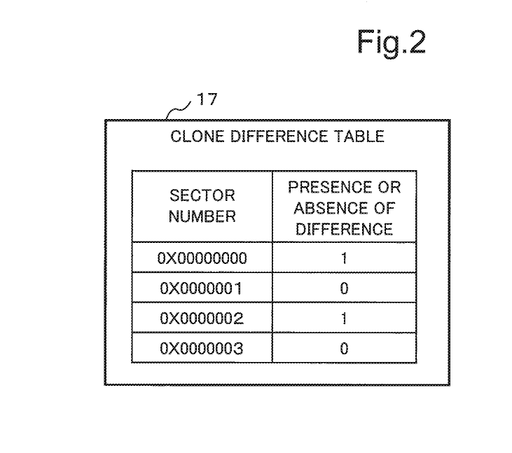

FIG. 2 shows a configuration example of the clone difference table 17. In the clone difference table 17, for all sectors of the clone storage unit 13, whether or not a difference with respect to master data has occurred in a clone by writing with respect to the clone that has occurred after acquisition of the clone is represented with 1 bit. In each bit of the clone difference table 17, 1 is stored in the case where a difference is present, and 0 in the case where a difference is absent (a difference has been eliminated), for example.

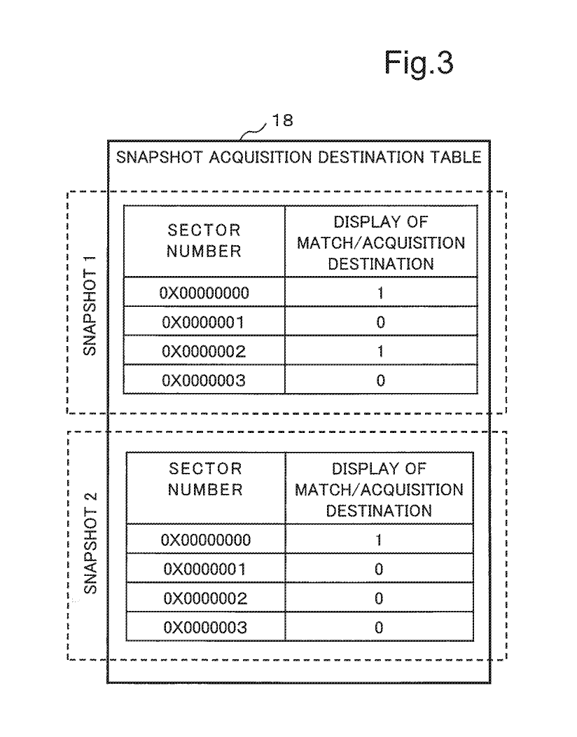

FIG. 3 shows a configuration example of the snapshot acquisition destination table 18. The snapshot acquisition destination table 18 includes an entry (portion surrounded by a dotted line in FIG. 3) for every version of snapshot data. In each entry of the snapshot acquisition destination table 18, for all sectors of corresponding versions, whether or not snapshot data and master data match is represented with 1 bit. In each bit of the snapshot acquisition destination table 18, 1 is stored in the case where these pieces of data do not match, and 0 in the case of a match, for example.

In the case where snapshot data and master data match, the snapshot control unit 16 can use the master data as the snapshot data. The snapshot control unit 16 acquires snapshot data from the snapshot storage unit 14 in the case where these pieces of data do not match, but can acquire snapshot data from the master storage unit 12 in the case where these pieces of data match.

A bit state 0 of the snapshot acquisition destination table 18 expresses all of the following states: a) snapshot data and master data match, b) snapshot data is acquirable from the master storage unit 12, and c) snapshot data is not saved in the snapshot storage unit 14.

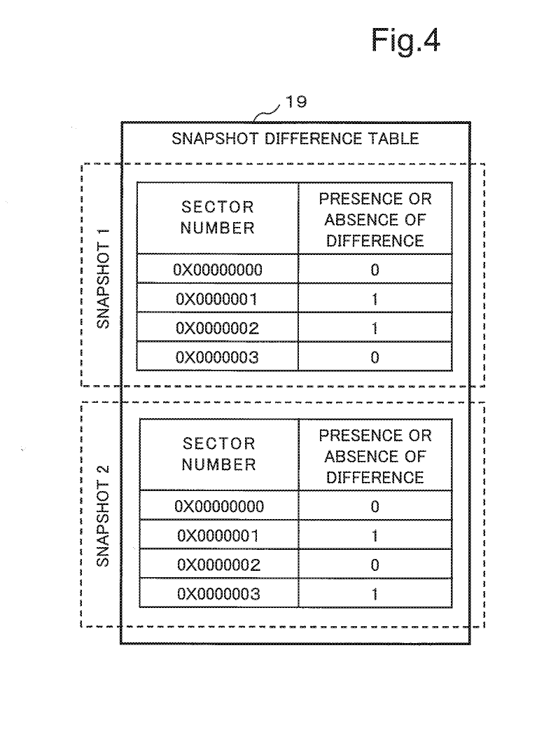

FIG. 4 shows a configuration example of the snapshot difference table 19. The snapshot difference table 19 includes an entry (portion surrounded by a dotted line in FIG. 4) for every version of snapshot data. In each entry, for all sectors of corresponding versions, whether or not a difference has occurred, between data at the point of backup acquisition and latest data corresponding to the clone storage unit 13 in the version, by writing into the clone storage unit 13 after acquisition of backup of the version is represented with 1 bit. That is, each bit represents whether or not a difference has occurred between snapshot data corresponding to the version and latest data corresponding to the clone storage unit 13. In each bit of the snapshot difference table 19, 1 is stored in the case where a difference is present, and 0 in the case where a difference is absent, for example.

### Operation

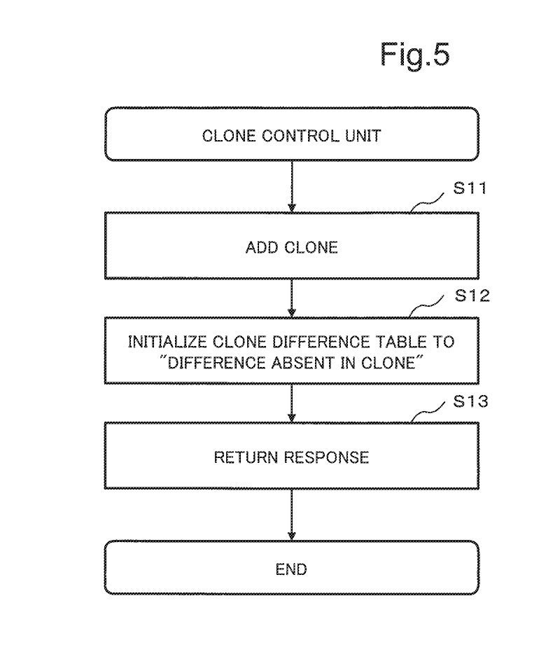

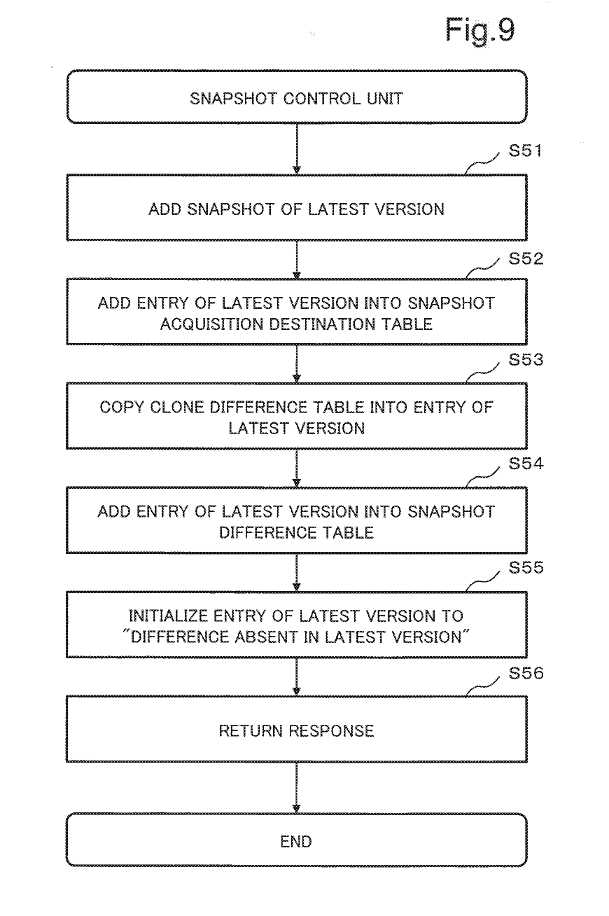

FIG. 5 to FIG. 8 are flowcharts showing the operation of the clone control unit 15. FIG. 9 to FIG. 13 are flowcharts showing the operation of the snapshot control unit 16.

FIG. 5 is a flowchart showing clone acquisition command processing by the clone control unit 15. The clone control unit 15 adds the clone storage unit 13 (S11) and causes all bits of the clone difference table 17 to be 0 to thereby record that a difference is absent in all sectors in the clone storage unit 13 (S12). Finally, the clone control unit 15 transmits an execution result to a transmission source of a command (S13).

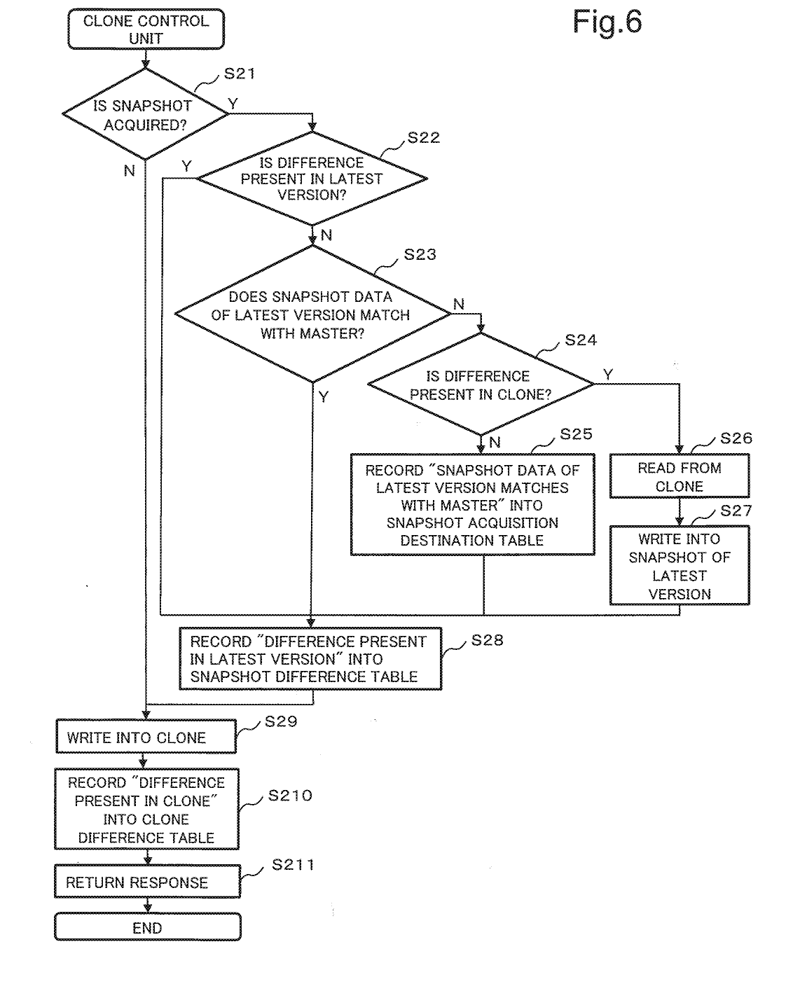

FIG. 6 is a flowchart showing write command processing by the clone control unit 15. The clone control unit 15 executes the following processing, for a sector shown by a sector number included in a write command.

The clone control unit 15 determines whether or not snapshot data is already acquired (S21). If snapshot data is already acquired (Y in S21), the clone control unit 15 determines the presence or absence of a difference in snapshot data corresponding to the latest version (S22). The clone control unit 15 executes this determination using a bit of an entry corresponding to the snapshot data corresponding to the latest version within the snapshot difference table 19.

If a difference does not exist (N in S22), the clone control unit 15 determines whether or not the snapshot data corresponding to the latest version and master data match (S23). The clone control unit 15 executes this determination using a bit of an entry corresponding to the snapshot data corresponding to the latest version within the snapshot acquisition destination table 18.

If these pieces of data do not match (N in S23), the clone control unit 15 determines the presence or absence of a difference in the clone storage unit 13, with a bit of the clone difference table 17 (S24).

If a difference does not exist in the clone (N in S24), the clone control unit 15 causes the bit of the entry corresponding to the snapshot data of the latest version to be 0, within the snapshot acquisition destination table 18. That is, the clone control unit 15 records that the snapshot data corresponding to the latest version and master data match (S25).

On the other hand, if a difference exists in the clone (Y in S24), the clone control unit 15 reads a byte data sequence from the clone storage unit 13 (S26) and writes that into the snapshot storage unit 14 corresponding to the snapshot data of the latest version (S27).

In the case where a difference in the snapshot data corresponding to the latest version exists (Y in S22), after processing of S25 or S27, the clone control unit 15 causes the bit of the entry corresponding to the snapshot data of the latest version to be 1, within the snapshot difference table 19. That is, the clone control unit 15 records that a difference has occurred in the snapshot data of the latest version (S28).

In the case where acquisition of snapshot data is absent (N in S21), or after processing of S28, the clone control unit 15 writes a byte data sequence into the clone storage unit 13 (S29) and causes the bit of the clone difference table 17 to be 1 (S210). Accordingly, the clone control unit 15 records, into the clone difference table 17, that a difference has occurred in the clone. Finally, the clone control unit 15 transmits an execution result to a transmission source of the command (S211).

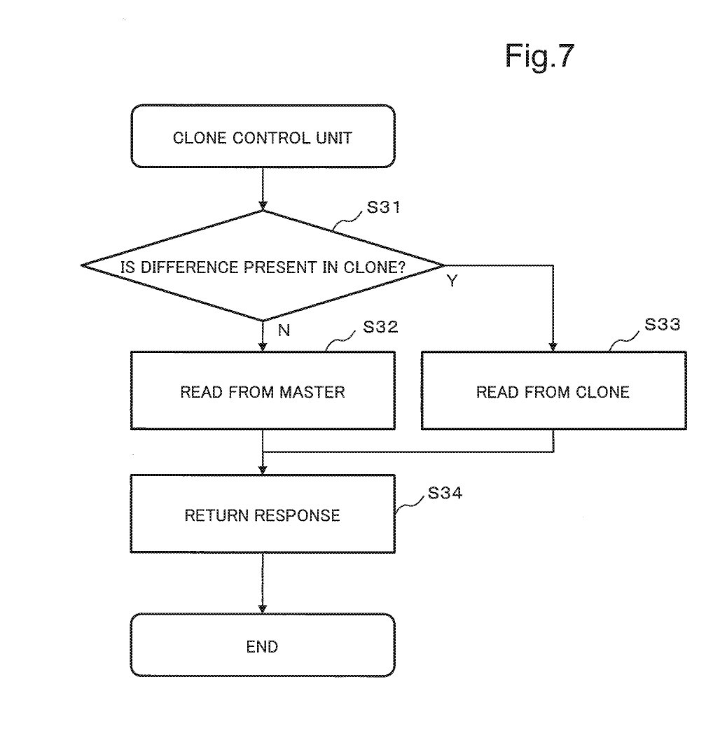

FIG. 7 is a flowchart showing read command processing by the clone control unit 15. The clone control unit 15 executes the following processing, for a sector corresponding to a sector number included in a read command.

The clone control unit 15 determines the presence or absence of a difference in a clone, with a bit of the clone difference table 17 (S31). If a difference does not exist in the clone (N in S31), the clone control unit 15 reads a byte data sequence from the master storage unit 12 (S32).

On the other hand, if a difference exists in the clone (Y in S31), the clone control unit 15 reads a byte data sequence from the clone storage unit 13 (S33).

After S32 or S33, the clone control unit 15 transmits an execution result and the read byte data sequence to a transmission source of the command (S34).

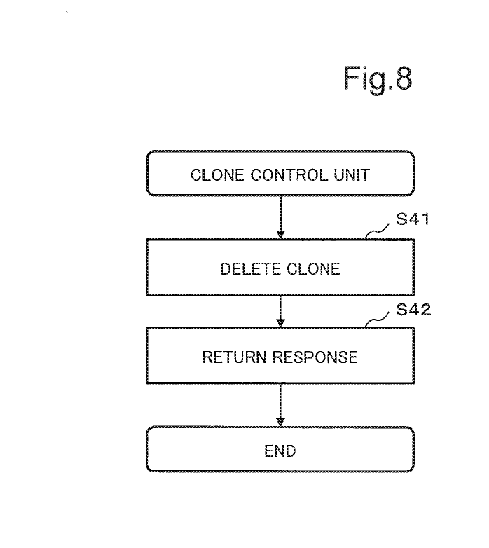

FIG. 8 is a flowchart showing clone delete command processing by the clone control unit 15. The clone control unit 15 deletes the clone storage unit 13 (S41) and transmits an execution result to a transmission source of a command (S42).

FIG. 9 is a flowchart showing snapshot acquisition command processing by the snapshot control unit 16.

The snapshot control unit 16 adds the snapshot storage unit 14 corresponding to a snapshot of a version to be acquired (S51). The snapshot control unit 16 adds, into the snapshot acquisition destination table 18, an entry corresponding to snapshot data corresponding to the version to be acquired (S52). The snapshot control unit 16 copies all bits of the clone difference table 17 into bits corresponding to the entry added into the snapshot acquisition destination table 18 (S53).

Further, the snapshot control unit 16 adds, with respect to the snapshot difference table 19, an entry corresponding to the snapshot data corresponding to the version to be acquired (S54). The snapshot control unit 16 causes all bits of the entry added into the snapshot difference table 19 to be 0 (difference absent) (S55). Finally, the snapshot control unit 16 transmits an execution result to a transmission source of a command (S56).

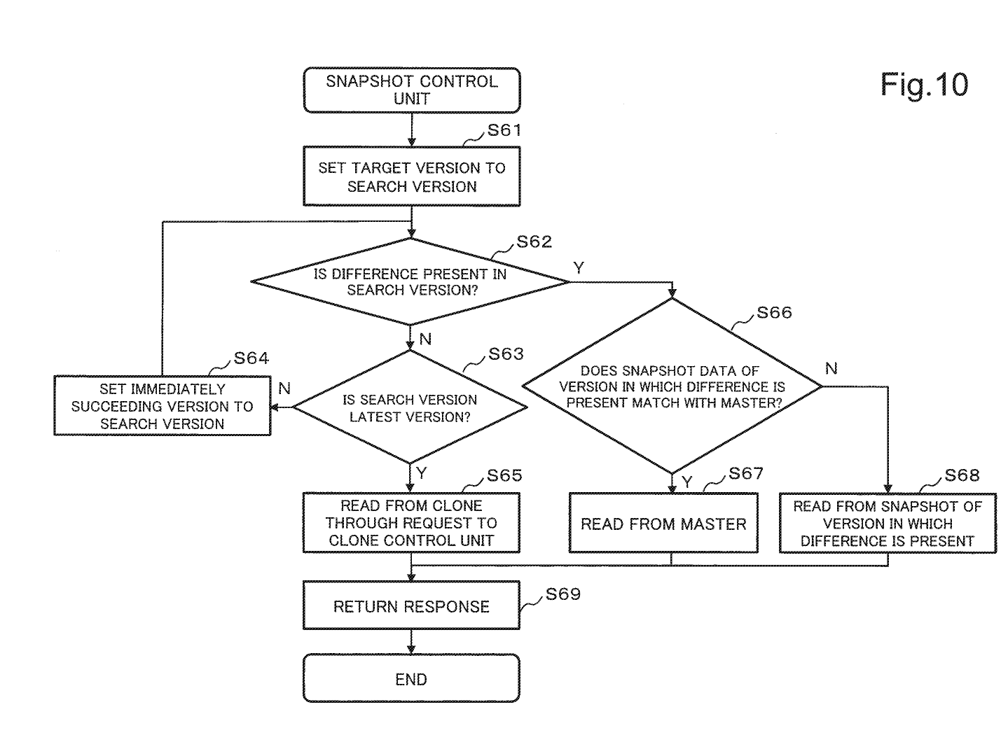

FIG. 10 is a flowchart showing snapshot read command processing by the snapshot control unit 16. The snapshot control unit 16 executes the following processing, for a sector corresponding to a sector number included in a snapshot read command.

The snapshot control unit 16 searches for a version in which a difference is present, with a bit of an entry corresponding to snapshot data of a target version and snapshot data of a later version within the snapshot difference table 19 (S61 to S64). The snapshot control unit 16 executes this search in chronological order including the target version. Herein, a target version is a version shown by a version number included in the snapshot read command.

If a difference does not exist in the snapshot data corresponding to the searched version (Y in S63), the snapshot control unit 16 reads a byte data sequence from the clone storage unit 13 through a request to the clone control unit 15 (S65).

If a difference exists in a snapshot of at least one version as a result of the search (Y in S62), the snapshot control unit 16 determines whether or not snapshot data in the version in which the difference exists and master data match (S66). This determination is performed by checking a bit of an entry corresponding to the snapshot data of the version in which the difference exists, within the snapshot acquisition destination table 18.

If these pieces of data match (Y in S66), the snapshot control unit 16 reads a byte data sequence from the master storage unit 12 (S67). If these pieces of data do not match (N in S66), the snapshot control unit 16 reads a byte data sequence from the snapshot storage unit 14 of the version in which the difference exists (S68).

After processing of S65, S67, or S68, the snapshot control unit 16 transmits an execution result and the read byte data sequence to a transmission source of the command (S69).

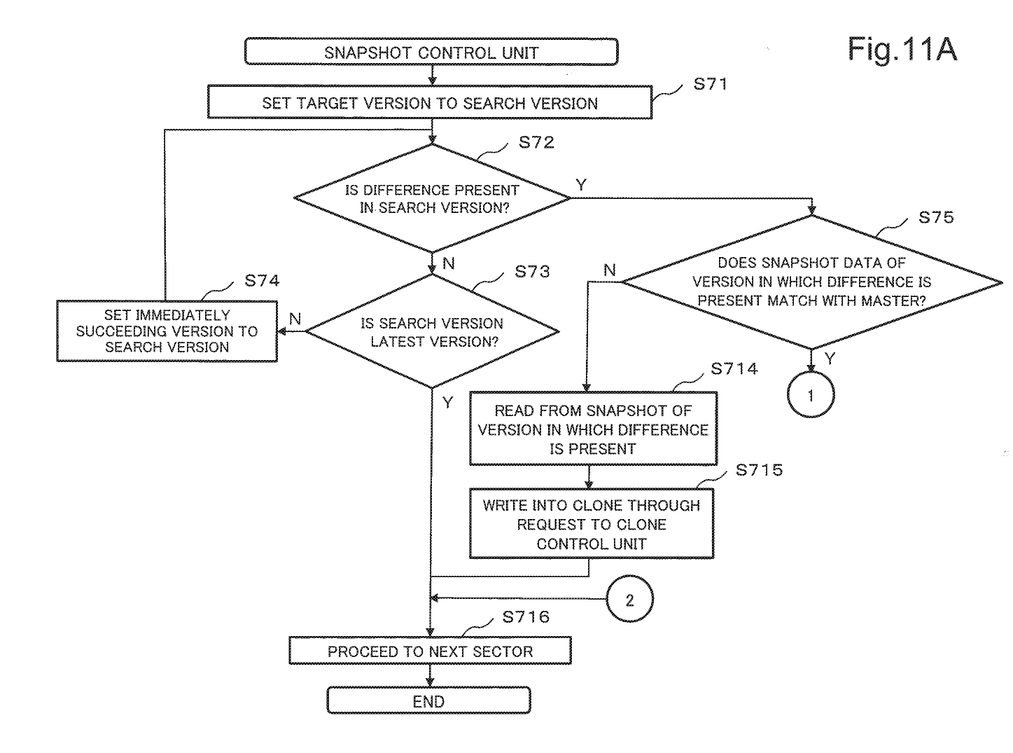

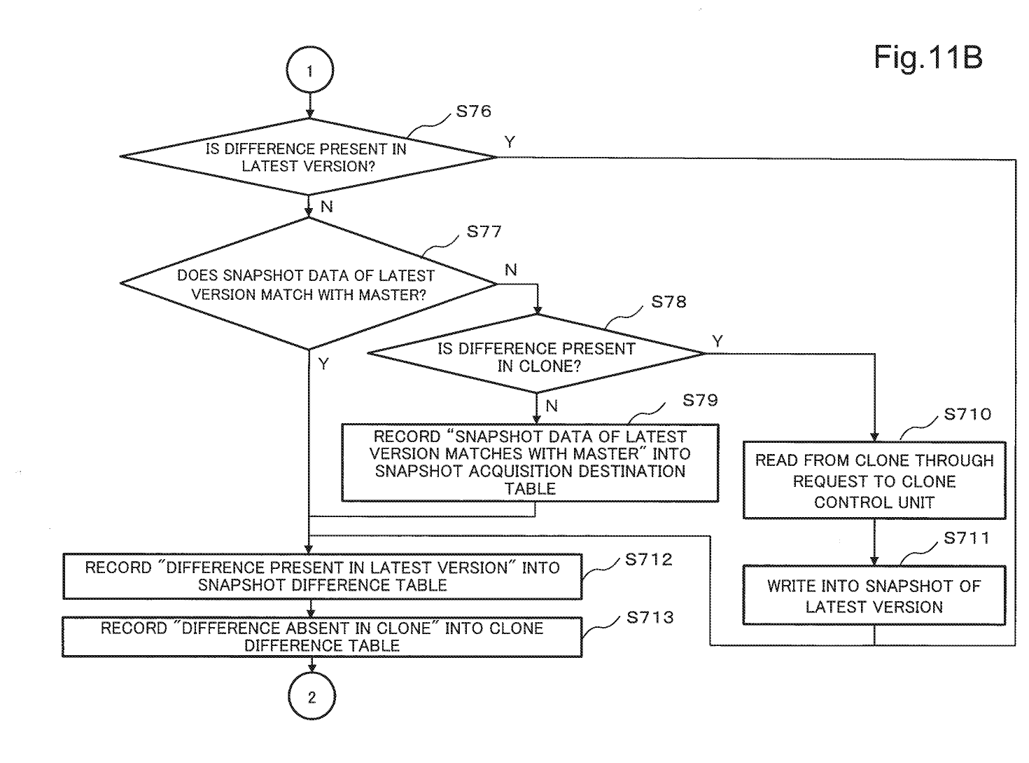

FIG. 11A and FIG. 11B are flowcharts showing snapshot restoration command processing by the snapshot control unit 16. The snapshot control unit 16 executes the following processing, for all sectors included in snapshot data corresponding to a target version, and transmits an execution result to a transmission source of a command after execution is complete. Herein, a target version is a version shown by a version number included in a snapshot restoration command.

The snapshot control unit 16 searches for a version in which a difference is present, with a bit of an entry corresponding to snapshot data of a target version and snapshot data of a later version within the snapshot difference table 19 (S71 to S74). The snapshot control unit 16 executes this search in chronological order including the target version.

If a difference exists in snapshot data corresponding to at least one version as a result of the search (Y in S72), the snapshot control unit 16 determines whether or not the snapshot data in the version in which the difference exists and master data match (S75). This determination is performed by checking a bit of an entry corresponding to the snapshot data of the version in which the difference exists, within the snapshot acquisition destination table 18.

If these pieces of data match (Y in S75), the snapshot control unit 16 determines the presence or absence of a difference in snapshot data corresponding to the latest version (S76). The snapshot control unit 16 executes this determination using a bit of an entry corresponding to the snapshot data of the latest version within the snapshot difference table 19.

If a difference does not exist (N in S76), the snapshot control unit 16 determines whether or not the snapshot data in the latest version and master data match (S77). The snapshot control unit 16 executes this determination using a bit of an entry corresponding to the snapshot data of the latest version within the snapshot acquisition destination table 18.

If these pieces of data do not match (N in S77), the snapshot control unit 16 determines the presence or absence of a difference in the clone, with a bit of the clone difference table 17 (S78).

If a difference does not exist in the clone (N in S78), the snapshot control unit 16 causes the bit of the entry corresponding to the snapshot data of the latest version within the snapshot acquisition destination table 18 to be 0 (S79). Accordingly, the snapshot control unit 16 records, into the snapshot acquisition destination table 18, that the snapshot data in the latest version and master data match.

On the other hand, if a difference exists in the clone (Y in S78), the snapshot control unit 16 commands the clone control unit 15 to read a byte data sequence from the clone storage unit 13 (S710). Then, the snapshot control unit 16 writes the read byte data sequence into the snapshot storage unit 14 of the latest version (S711).

In the case where the snapshot data corresponding to the latest version and master data match (Y in S77), the snapshot control unit 16 causes the bit of the entry corresponding to the snapshot data of the latest version within the snapshot difference table 19 to be 1 (S712). Accordingly, the snapshot control unit 16 records, into the snapshot difference table 19, that a difference has occurred in the snapshot data corresponding to the latest version. The snapshot control unit 16 performs the same processing, also after processing of S79 or S711.

In the case where a difference in the snapshot data corresponding to the latest version is present (Y in S76), or after processing of S712, the snapshot control unit 16 records that a difference of the clone has been eliminated, by causing a bit of the clone difference table 17 to be 0 (S713). That is, in this case, a target sector is restored to a state where differential data is absent in the clone storage unit 13.

On the other hand, if the snapshot data corresponding to the version in which the difference is present and master data do not match (N in S75), the snapshot control unit 16 reads a byte data sequence from the snapshot storage unit 14 of the version in which the difference exists (S714). The snapshot control unit 16 writes the read byte data sequence into the clone storage unit 13 through a request to the clone control unit 15 (S715). That is, in this case, a target sector is restored by snapshot data stored in the snapshot storage unit 14.

Further, in the case where a version in which a difference is present does not exist (Y in S73), or after processing of S713 or S715, the snapshot control unit 16 proceeds with the processing to the next sector (S716).

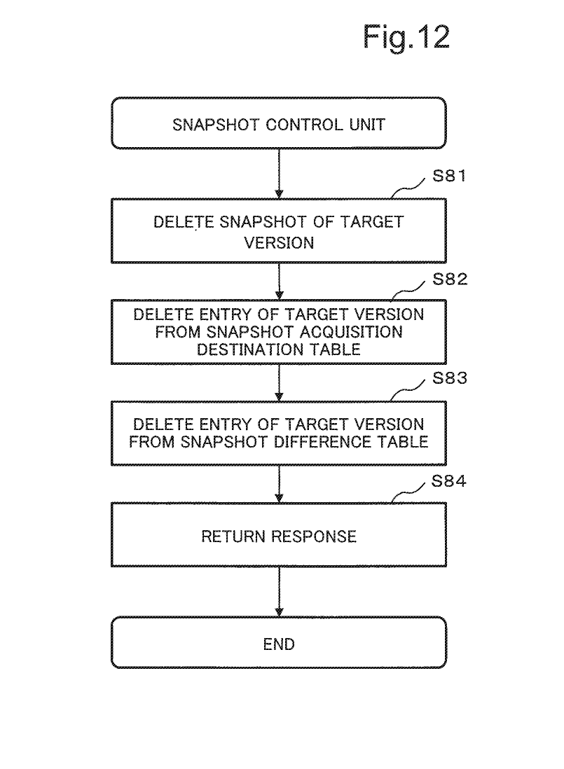

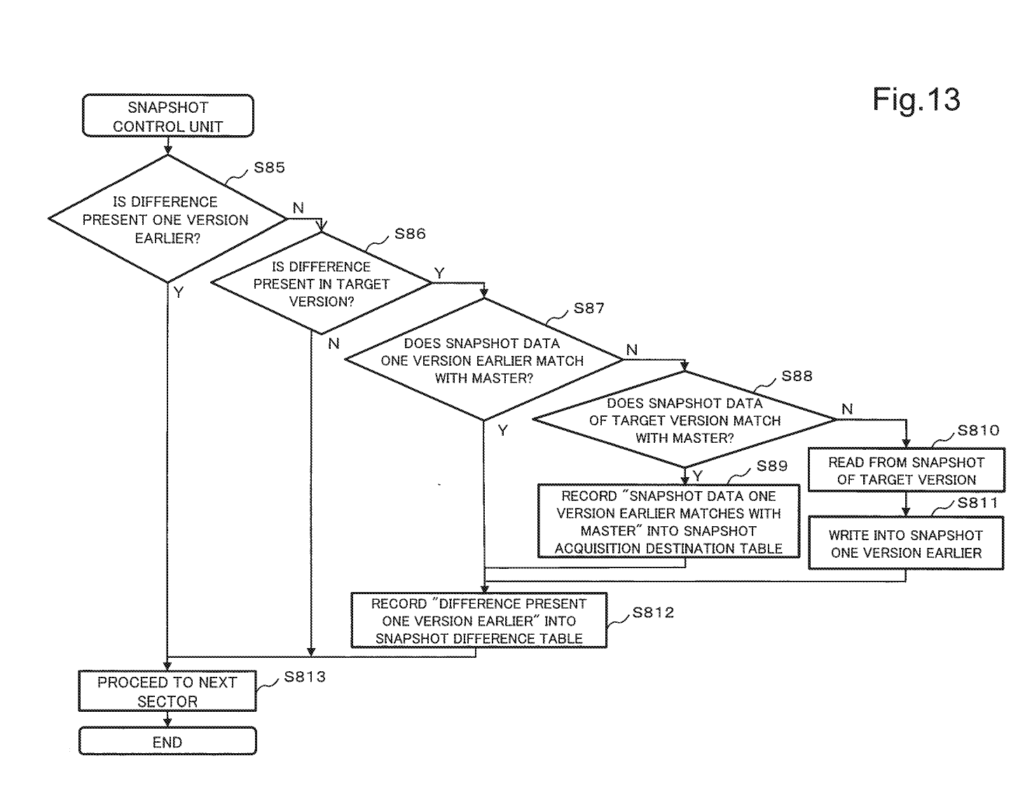

FIG. 12 and FIG. 13 are flowcharts showing snapshot delete command processing by the snapshot control unit 16.

In this command processing, the snapshot control unit 16 determines the presence or absence of snapshot data corresponding to a version immediately before a snapshot of a target version. Herein, a target version is a version shown by a version number included in a snapshot delete command.

If snapshot data corresponding to the immediately previous version does not exist, the snapshot control unit 16 executes the processing in FIG. 12 as follows.

The snapshot control unit 16 deletes the snapshot storage unit 14 of the target version (S81). Next, the snapshot control unit 16 deletes an entry corresponding to snapshot data corresponding to the target version from the snapshot acquisition destination table 18 (S82) and deletes an entry corresponding to the snapshot data corresponding to the target version from the snapshot difference table 19 (S83). Finally, the snapshot control unit 16 transmits an execution result to a transmission source of the command (S84).

On the other hand, if snapshot data corresponding to the immediately previous version exists, the snapshot control unit 16 executes the processing of FIG. 13, for all sectors included in the snapshot data corresponding to the target version, and executes the processing of FIG. 12 after execution is complete.

The processing of FIG. 13 is as follows.

The snapshot control unit 16 determines the presence or absence of a difference in the snapshot data corresponding to the version that is one version earlier, with a bit of an entry corresponding to the snapshot data corresponding to the version immediately before the target version within the snapshot difference table 19 (S85).

If a difference does not exist in the snapshot data corresponding to the immediately previous version (N in S85), the snapshot control unit 16 determines the presence or absence of a difference in snapshot data corresponding to the target version (S86). This determination is performed by checking a bit of an entry corresponding to the snapshot data of the target version within the snapshot difference table 19.

If a difference exists in the snapshot data corresponding to the target version (Y in S86), the snapshot control unit 16 determines whether or not the snapshot data corresponding to the version that is one version earlier and master data match (S87). This determination is performed by checking a bit of an entry corresponding to the snapshot data of the version that is one version earlier, within the snapshot acquisition destination table 18.

If the snapshot data one version earlier and master data do not match (N in S87), the snapshot control unit 16 determines whether or not the snapshot data in the target version and master data match (S88). This determination is performed by checking a bit of an entry corresponding to the snapshot data corresponding to the target version, within the snapshot acquisition destination table 18.

If the snapshot data in the target version and master data match (Y in S88), the snapshot control unit 16 causes the bit of the entry corresponding to the snapshot data of the immediately previous version to be 0, within the snapshot acquisition destination table 18. Accordingly, the snapshot control unit 16 records that the snapshot data corresponding to the immediately previous version and master data match (S89).

On the other hand, if the snapshot data in the target version and master data do not match (N in S88), the snapshot control unit 16 reads a byte data sequence from the snapshot storage unit 14 of the target version (S810). The snapshot control unit 16 writes the read byte data sequence into the snapshot storage unit 14 of the immediately previous version (S811).

In the case where the snapshot data corresponding to the immediately previous version and master data match (Y in S87), or after processing of S89 or S811, the snapshot control unit 16 performs the following processing. The snapshot control unit 16 causes the bit of the entry corresponding to the snapshot data of the immediately previous version to be 1 within the snapshot difference table 19 to thereby record that a difference has occurred in the snapshot data corresponding to the immediately previous version (S812).

In the case where a difference exists in the snapshot data corresponding to the immediately previous version (Y in S85), in the case where a difference does not exist in the snapshot data corresponding to the target version (Y in S86), or after processing of S812, the snapshot control unit 16 proceeds with the processing to the next sector (S813).

### Modified Example

In this exemplary embodiment, a command exchanged by the backup control device 10 and the host computer 20 is, for example, a command of the Small Computer System Interface (SCSI) standard. Note that an input-output interface standard to be used is not limited as such, as long as exchange of information described above is possible.

The master storage unit 12, the clone storage unit 13, and the snapshot storage unit 14 may be a storage device capable of instructing reading and writing in sectors or similar data storage units of fixed length. The specific configuration of the storage device is not considered.

In the exemplary embodiment, the clone storage unit 13 and the snapshot storage unit 14 are capable of any addition or deletion with respect to a disk array. Note that the clone storage unit 13 or the snapshot storage unit 14 may be not capable of addition and deletion, as long as a sufficient number of storage units having sufficient capacity to enable storage of all of the sectors at the time of acquisition are available. The clone storage unit 13 and the snapshot storage unit 14 may be configured of a storage device having all of the storage volume in advance, for example.

### Effect

The backup control device 10 according to this exemplary embodiment can acquire snapshot data efficiently, for backup of the clone storage unit 13. The reason is that the clone control unit 15 and the snapshot control unit 16 (or the control unit 1A) do not acquire snapshot data into the snapshot storage unit 14 again, when snapshot data and master data corresponding to the master storage unit 12 match. In this case, the snapshot control unit 16 (or the control unit 1A) reads master data corresponding to the master storage unit 12, when snapshot data is necessary.

### Second Exemplary Embodiment

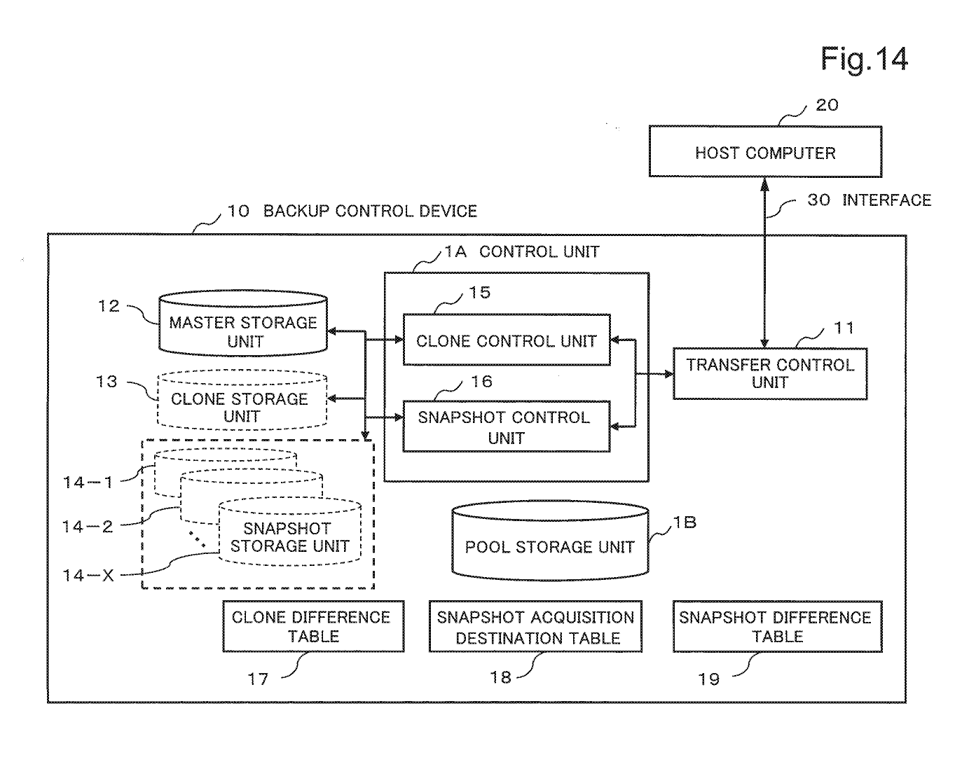

FIG. 14 is a diagram showing the configuration of the backup control device 10 according to a second exemplary embodiment of the present disclosure.

The backup control device 10 according to the exemplary embodiment includes a pool storage unit 1B. In this exemplary embodiment, the clone storage unit 13 and the snapshot storage unit 14 are virtual storage devices configured of a virtual sector that is a sector not having reality. This virtual storage device stores data in the pool storage unit 1B configured of a real sector having reality.

That is, the clone storage unit 13 in this exemplary embodiment is an input-output control unit that receives an input-output command from the clone control unit 15 and maps a virtual sector of itself to a real sector of the pool storage unit 1B for input or output. In a similar manner, the snapshot storage unit 14 is an input-output control unit that receives an input-output command from the snapshot control unit 16 and maps a virtual sector of itself to a real sector of the pool storage unit 1B for input or output.

Since a virtual storage device does not consume a storage area until a write command is actually executed, the storage area can be reduced.

The virtual storage device in this exemplary embodiment processes commands including a write command, a read command, and a release command.

Upon receiving a write command, the virtual storage device newly allocates a real sector with respect to a virtual sector of a designated sector number, stores a designated byte data sequence into the allocated real sector, and transmits an execution result to a transmission source of the command. Thereafter, allocation of the allocated real sector with respect to other virtual sectors becomes impossible until release.

Upon receiving a read command, the virtual storage device reads and transmits, to a transmission source of the command, a byte data sequence stored on a real sector allocated to a virtual sector of a designated sector number.

Upon receiving a release command, the virtual storage device releases, from a virtual sector of a designated sector number, a real sector allocated to the virtual sector. Thereafter, allocation of the released real sector with respect to other virtual sectors becomes possible.

Upon elimination of a difference of a sector on the clone storage unit 13, the virtual storage device described above releases a real sector allocated to the sector. In a similar manner, upon a change in content that data of a sector of the snapshot storage unit 14 matches with master data, the virtual storage device releases a real sector allocated to the virtual sector.

The backup control device 10 according to this exemplary embodiment enables a further reduction in storage area. The reason is that the clone storage unit 13 and the snapshot storage unit 14 are virtual storage devices configured of a virtual sector that is a sector not having reality. A virtual storage device can avoid storage of data with redundant content in multiple parts.

### Third Exemplary Embodiment

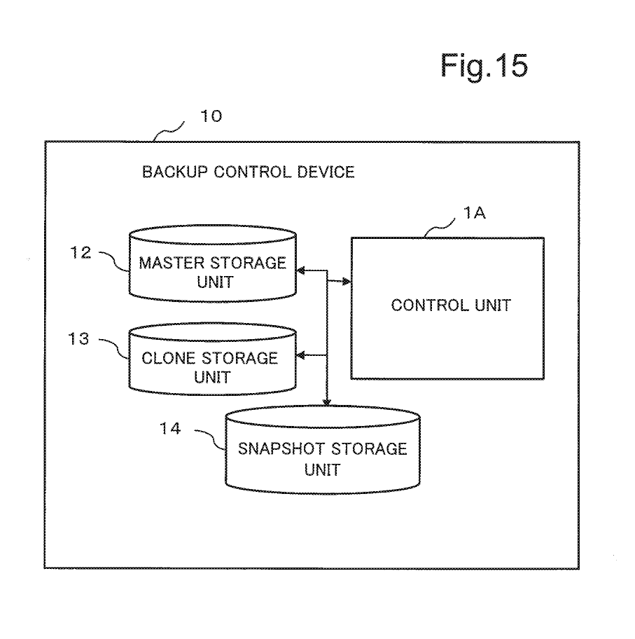

FIG. 15 is a diagram showing the configuration of the backup control device 10 according to a third exemplary embodiment of the present disclosure. The backup control device 10 of this exemplary embodiment includes the master storage unit 12, the clone storage unit 13, the snapshot storage unit 14, and the control unit 1A.

The master storage unit 12 stores master data. The clone storage unit 13 stores the latest piece of differential data relative to master data. The snapshot storage unit 14 stores snapshot data that is data at the time of acquisition of backup of the clone storage unit 13.

Upon receiving an update request for the clone storage unit 13 after backup acquisition, the control unit 1A determines whether or not differential data is present in the clone storage unit 13. If differential data is present, the control unit 1A saves the differential data into the snapshot storage unit 14. If differential data is absent, acquisition of snapshot data into the snapshot storage unit 14 is not performed.

The backup control device 10 according to the exemplary embodiment can acquire snapshot data efficiently, for backup of the clone storage unit 13. The reason is that the control unit 1A does not acquire snapshot data into the snapshot storage unit 14 again, when snapshot data and master data of the master storage unit 12 match. In this case, the control unit 1A reads master data of the master storage unit 12, when snapshot data is necessary.

In a similar manner to the first exemplary embodiment, the control unit 1A may be implemented separately to the clone control unit 15 and the snapshot control unit 16, for example.

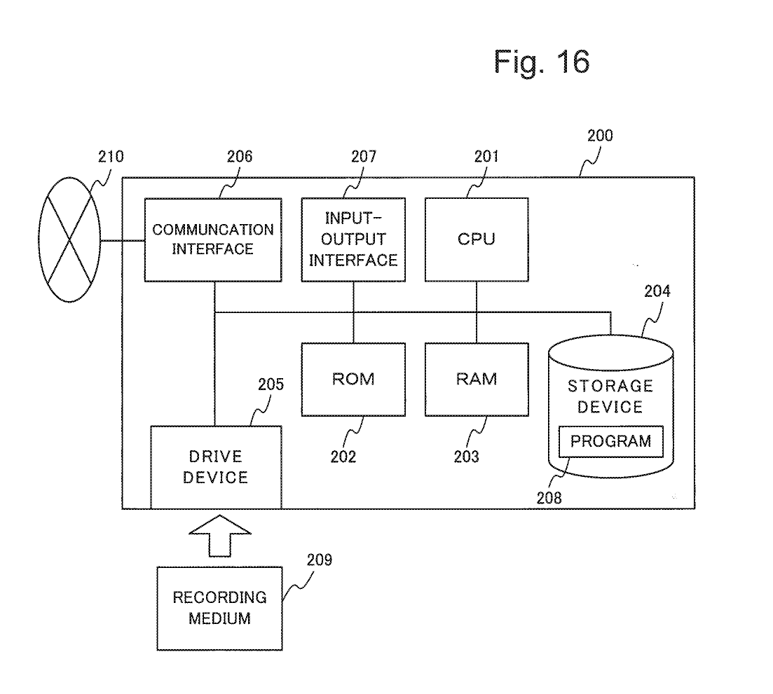

FIG. 16 is a block diagram showing an example of the hardware configuration of a computer device 200 in which the backup control device 10 is implemented. The computer device 200 includes a central processing unit (CPU) 201, a read-only memory (ROM) 202, a random-access memory (RAM) 203, a storage device 204, a drive device 205, a communication interface 206, and an input-output interface 207. The backup control device 10 can be realized by the configuration (or a part thereof) shown in FIG. 16.

The CPU 201 executes a program 208 using the RAM 203. The program 208 may be stored in the ROM 202. The program 208 may be recorded in a recording medium 209, such as a flash memory, and read by the drive device 205, or may be transmitted from an external device via a network 210. The communication interface 206 exchanges data with an external device via the network 210. The input-output interface 207 exchanges data with a peripheral device such as an input device or a display device. The communication interface 206 and the input-output interface 207 can function as means for acquiring or outputting data.

The backup control device 10 may be configured of a single circuitry (such as a processor) or may be configured of a combination of multiple circuitry. Circuitry referred to herein may be either dedicated or general purpose.

While the present disclosure has been described above with reference to exemplary embodiments, the present disclosure is not limited to the exemplary embodiments described above. To the configuration or details of the present disclosure, various changes comprehensible to those skilled in the art can be applied within the scope of the present disclosure.

### REFERENCE SIGNS LIST

10 Backup control device

11 Transfer control unit

12 Master storage unit

13 Clone storage unit

14 Snapshot storage unit

15 Clone control unit

16 Snapshot control unit

17 Clone difference table

18 Snapshot acquisition destination table

19 Snapshot difference table

1A Control unit

1B Pool storage unit

20 Host computer

30 Interface

1. A backup control device comprising:
a master storage unit that stores master data;
a clone storage unit that stores latest differential data of the master data;
a snapshot storage unit that stores snapshot data, the snapshot data being data at time of acquisition of backup of the clone storage unit; and
a control unit that saves differential data into the snapshot storage unit when the differential data is present in the clone storage unit, and does not perform acquisition of the snapshot data when differential data is absent in the clone storage unit.

2. The backup control device of claim 1, wherein, upon receiving a read request for data corresponding to a version immediately before the differential data stored in the clone storage unit, the control unit reads, when snapshot data corresponding to the version immediately before the differential data is saved in the snapshot storage unit, the snapshot data and reads the master data when the snapshot data corresponding to the version immediately before the differential data is not saved in the snapshot storage unit.

3. The backup control device of claim 1, wherein, upon receiving a restoration request for data corresponding to a version immediately before the differential data stored in the clone storage unit, the control unit reads snapshot data and restores the snapshot data into the clone storage unit when the snapshot data is saved in the snapshot storage unit, and restores the clone storage unit to a state where the differential data is absent when the snapshot data is not saved, the snapshot data being snapshot data at the version immediately before the differential data stored in the clone storage unit.

4. The backup control device of claim 1, wherein
a plurality of the snapshot storage units are included, each of the plurality of snapshot storage units corresponding to each of a plurality of versions; and
upon receiving a delete request for the snapshot storage unit corresponding to a designated version, the control unit writes, when snapshot data corresponding to a version immediately before the designated version is saved in the snapshot storage unit corresponding to the designated version, the snapshot data into the snapshot storage unit corresponding to the version immediately before the designated version and records, when the snapshot data corresponding to a version immediately before the designated version is not saved, that snapshot data is not saved in the snapshot storage unit corresponding to the version immediately before the designated version.

5. The backup control device of claim 1, comprising a pool storage unit,
wherein the clone storage unit and the snapshot storage unit are a virtual storage device of which a storage area corresponding to a volume of stored data is allocated in the pool storage unit.

6. A backup control method, comprising:
storing master data; and
upon receiving an update request of a clone storage unit that stores latest differential data of the master data after acquisition of backup of the clone storage unit, saving, when the differential data is present in the clone storage unit, the differential data into a snapshot storage unit, and not performing acquisition of the snapshot data when differential data is absent in the clone storage unit.

7. The backup control method of claim 6, wherein, upon receiving a read request for data corresponding to a version immediately before the differential data stored in the clone storage unit, reading, when snapshot data corresponding to the version immediately before the differential data is saved in the snapshot storage unit, the snapshot data and reading the master data when snapshot data corresponding to the version immediately before the differential data is not saved in the snapshot storage unit.

8. The backup control method of claim 6, wherein, upon receiving a restoration request for data corresponding to a version immediately before the differential data stored in the clone storage unit, reading snapshot data and restoring the snapshot data into the clone storage unit when the snapshot data is saved in the snapshot storage unit, and restoring the clone storage unit to a state where the differential data is absent when the snapshot data is not saved, the snapshot data being snapshot data at the version immediately before the differential data stored in the clone storage unit.

9. The backup control method of claim 6, wherein
a plurality of the snapshot storage units are included, each of the plurality of snapshot storage units corresponding to each of a plurality of versions; and
upon receiving a delete request for the snapshot storage unit corresponding to a designated version, writing, when snapshot data corresponding to a version immediately before the designated version is saved in the snapshot storage unit corresponding to the designated version, the snapshot data into the snapshot storage unit corresponding to the version immediately before the designated version and recording, when snapshot data corresponding to a version immediately before the designated version is not saved, that snapshot data is not saved in the snapshot storage unit corresponding to the version immediately before the designated version.

10. A non-transitory computer readable recording medium storing a program for causing a computer to execute:
processing of storing master data; and
upon receiving an update request of a clone storage unit that stores latest differential data of the master data after acquisition of backup of the clone storage unit, processing of saving, when the differential data is present in the clone storage unit, the differential data into a snapshot storage unit, and not performing acquisition of the snapshot data when differential data is absent in the clone storage unit.
